(19) United States
(12) Patent Application Publication
(10) Pub. No.: US 2007/0213430 A1
(43) Pub. Date: Sep. 13, 2007

(54) POLYMERIC COMPOSITIONS CONTAINING MODIFIED POLYVINYL ALCOHOLS

(76) Inventors: Werner Bauer, Burgkirchen (DE); Ulf Deitrich, Wachenheim (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/595,315

(22) PCT Filed: Oct. 7, 2004
(86) PCT No.: PCT/EP04/11213

§ 371 Date: Feb. 19, 2007

(30) Foreign Application Priority Data
Oct. 9, 2003 (DE) 103469737

(51) Int. Cl. C04B 24/26

(52) U.S. Cl. 524/5; 524/2

(57) ABSTRACT

The invention relates to polymeric compositions containing modified polyvinyl alcohols embodied in the form of the aqueous dispersion thereof or water-redispersible powders based on homo or mixed polymerisates of one or several monomers of a group comprising linear or branched alkylcarboxylic acid vinyl esters containing from 1 to 15 C atoms, methacrylic acid esters and alcohol acrylic acid esters containing from 1 to 15 C atoms, vinyl aromatics, olefins, dienes and vinyl halogenides. The inventive compositions are characterised in that the modified polyvinyl alcohols contained therein exhibit a latent carboxylic acid function and/or comprise phosphorus-containing comonomer units.

The invention relates to polymer composition comprising modified polyvinyl alcohols in the form of their aqueous polymer dispersions or water-redispersible polymer powders.

Polymers stabilized with protective colloids are used, in particular, in the form of their aqueous dispersions or of water-redispersible polymer powders in many applications, for example as coating compositions or adhesives for a variety of substrates, for example cement-containing building adhesives. Protective colloids used are generally polyvinyl alcohols. Polyvinyl alcohol is a known and much-used protective colloid for polymer dispersions and is also used as atomization aid for the spray drying of these.

However, as water-soluble polymer having a high ion stability, polyvinyl alcohol displays a high sensitivity toward intruding water in the field of hydraulically setting mortar systems such as cement-containing tile adhesives. Owing to its glass transition temperature, polyvinyl alcohol also displays a high sensitivity to thermal stress, for example in the case of tiles which have been laid on top of floor heating.

It is therefore an object of the invention to provide polymer compositions which comprise polyvinyl alcohol and do not have the abovementioned disadvantages. In particular, building material compositions modified with such polymer composition should display improved adhesive pull strengths, especially after storage under wet and hot conditions.

It has surprisingly been found that this object can be achieved by means of polyvinyl alcohols which contain a latent carboxylic acid function or comprise phosphorus-containing monomer units.

The invention provides polymer compositions comprising modified polyvinyl alcohols in the form of their aqueous dispersions and water-redispersible powders which are based on homopolymers or copolymers of one or more monomers from the group consisting of vinyl esters of unbranched or branched alkylcarboxylic acids having from 1 to 15 carbon atoms, methacrylic esters and acrylic esters of alcohols having from 1 to 15 carbon atoms, vinylaromatics, olefins, dienes and vinyl halides, characterized in that the modified polyvinyl alcohols present are polyvinyl alcohols having a latent carboxylic acid function and/or polyvinyl alcohols comprising phosphorus-containing comonomer units.

Polyvinyl alcohols having a latent carboxylic acid function are obtained by copolymerizing vinyl acetate with one or more comonomers from the group consisting of methacrylic esters and acrylic esters of alcohols having from 1 to 15 carbon atoms and subsequently hydrolyzing the copolymer obtained in this way. In general, from 0.5 to 50% by weight, preferably from 1 to 20% by weight, each based on the total monomer, of (meth)acrylic esters are copolymerized. Preference is given to acrylic esters of C₁-C₄-alcohols, particularly preferably methyl acrylate, ethyl acrylate, n-propyl acrylate, n- and t-butyl acrylate.

Polyvinyl alcohols having phosphorus-containing comonomer units are obtained by copolymerizing vinyl acetate with one or more comonomers from the group consisting of vinylphosphonic acid, methacrylic esters and acrylic esters of polyalkylene glycols which are end-modified by phosphoric acid and have C₂-C₄-alkylene units and from 1 to 100 oxyalkylene units, preferably from 1 to 20 oxyalkylene units, particularly preferably poly-ethylene glycols having from 3 to 13 oxyethylene units, and subsequently hydrolyzing the copolymer obtained in this way. Polyvinyl alcohols having vinylphosphonic acid groups can also be obtained by firstly hydrolyzing the polyvinyl acetate and subsequently reacting the hydrolysis product with diphosphorus pentoxide. In general, from 0.5 to 50% by weight, preferably from 0.5 to 10% by weight, in each case based on total monomer, of phosphorus-containing comonomers is copolymerized.

The modified polyvinyl alcohols can be produced by known processes for polyvinyl alcohol production. The polymerization is preferably carried out in organic solvents at elevated temperatures using peroxides, hydroperoxides and azo compounds as initiator. Solvents used are preferably alcohols such as methanol or propanol. The resulting vinyl acetate copolymer is preferably not isolated but subjected directly to hydrolysis. Hydrolysis is carried out by known methods, for example using methanolic NaOH as catalyst. After hydrolysis, the solvent is replaced by water in a work-up by distillation. The protective colloid is preferably not isolated but used directly as aqueous solution for the polymerization or for spray drying. The degree of hydrolysis is generally from 70 to 100 mol %, preferably from 85 to 95 mol %, in each case based on vinyl acetate units.

Vinyl esters suitable for the base polymer are esters of carboxylic acids having from 1 to 15 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having from 9 to 13 carbon atoms, for example VeoVa9® or VeoVa10® (trade names of Shell). Particular preference is given to vinyl acetate.

Suitable methacrylic esters or acrylic esters are esters of unbranched or branched alcohols having from 1 to 15 carbon atoms, e.g. methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate. Preference is given to methyl acrylate, methyl methacrylate, n-butyl acrylate and 2-ethylhexyl acrylate.

Examples of olefins and dienes are ethylene, propylene and 1,3-butadiene. Suitable vinylaromatics are styrene and vinyltoluene. A suitable vinyl halide is vinyl chloride.

If desired, from 0.05 to 50% by weight, preferably from 1 to 10% by weight, based on the total weight of the base polymer, of auxiliary monomers can also be copolymerized. Examples of auxiliary monomers are ethylenically unsaturated mono- and dicarboxylic acids, preferably acrylic acid, methacrylic acid, fumaric acid and maleic acid; ethylenically unsaturated carboxamides and nitriles, preferably acrylamide and acrylonitrile; monoesters and diesters of fumaric acid and maleic acid, e.g. the diethyl and diisopropyl esters, and also maleic anhydride, ethylenically unsaturated sulfonic acids or salts thereof, preferably vinylsulfonic acid, 2-acrylamido-2-methylpropanesulfonic acid. Further examples are precrosslinking comonomers such as multiply ethylenically unsaturated comonomers, for example divinyl adipate, diallyl maleate, allyl meth-acrylate or triallyl cyanurate, or postcrosslinking comonomers, for example acrylamidoglycolic acid (AGA), methyl methylacrylamidoglycolate (MMAG), N-methylol-acrylamide (NMA), N-methylolmethacrylamide (NMMA), N-methylolallyl carbamate, alkyl ethers such as the isobutoxy ether or ester of N-methylolacrylamide, of N-methylolmethacrylamide and of N-methylolallyl carbamate. Epoxy-functional comonomers such as glycidyl methacrylate and glycidyl acrylate are also suitable as auxiliary monomers. Further examples are silicon-functional comonomers such as acryloxypropyltri(alkoxy)silanes and methacryloxypropyltri(alkoxy)-silanes, vinyltrialkoxysilanes and vinylmethyldi-alkoxysilanes, with methoxy, ethoxy and ethoxypropylene glycol ether radicals, for example, being able to be present as alkoxy groups. Mention may also be made of monomers having hydroxy or CO groups, for example hydroxyalkyl methacrylates and acrylates, e.g. hydroxy-ethyl, hydroxypropyl or hydroxybutyl acrylate or methacrylate, and also compounds such as diacetone-acrylamide and acetylacetoxyethyl acrylate or methacrylate.

Examples of suitable homopolymers and copolymers are vinyl acetate homopolymers, copolymers of vinyl acetate with ethylene, copolymers of vinyl acetate with ethylene and one or more further vinyl esters, copolymers of vinyl acetate with ethylene and acrylic esters, copolymers of vinyl acetate with ethylene and vinyl chloride, styrene-acrylic ester copolymers, styrene-1,3-butadiene copolymers.

Preference is given to vinyl acetate homopolymers;

copolymers of vinyl acetate with from 1 to 40% by weight of ethylene;

copolymers of vinyl acetate with from 1 to 40% by weight of ethylene and from 1 to 50% by weight of one or more further comonomers selected from the group consisting of vinyl esters having from 1 to 12 carbon atoms in the carboxylic acid radical, e.g. vinyl propionate, vinyl laurate, vinyl esters of alpha-branched carboxylic acids having from 9 to 13 carbon atoms, e.g. VeoVa9, VeoVa10, VeoVa11;

copolymers of vinyl acetate, from 1 to 40% by weight of ethylene and preferably from 1 to 60% by weight of acrylic esters of unbranched or branched alcohols having from 1 to 15 carbon atoms, in particular n-butyl acrylate or 2-ethylhexyl acrylate; and

copolymers comprising from 30 to 75% by weight of vinyl acetate, from 1 to 30% by weight of vinyl laurate or vinyl esters of an alpha-branched carboxylic acid having from 9 to 11 carbon atoms and from 1 to 30% by weight of acrylic esters of unbranched or branched alcohols having from 1 to 15 carbon atoms, in particular n-butyl acrylate or 2-ethylhexyl acrylate, which additionally contain from 1 to 40% by weight of ethylene;

copolymers comprising vinyl acetate, from 1 to 40% by weight of ethylene and from 1 to 60% by weight of vinyl chloride; with

the copolymers being able to additionally contain the auxiliary monomers mentioned in the amounts indicated and the percentages by weight in each case adding up to 100% by weight.

Preference is also given to copolymers of n-butyl acrylate or 2-ethylhexyl acrylate or copolymers of methyl methacrylate with n-butyl acrylate and/or 2-ethylhexyl acrylate;

styrene-acrylic ester copolymers with one or more monomers from the group consisting of methyl acrylate, ethyl acrylate, propyl acrylate, n-butyl acrylate, 2-ethylhexyl acrylate;

vinyl acetate-acrylic ester copolymers with one or more monomers from the group consisting of methyl acrylate, ethyl acrylate, propyl acrylate, n-butyl acrylate, 2-ethylhexyl acrylate and, if desired, ethylene; styrene-1,3-butadiene copolymers;

with the polymers being able to additionally contain the auxiliary monomers mentioned in the amounts indicated and the percentages by weight in each case adding up to 100% by weight.

The choice of monomers or the choice of the proportions by weight of the comonomers is generally made so that a glass transition temperature Tg of from −50° C. to +50° C., preferably from −30° C. to +40° C., results. The glass transition temperature Tg of the polymers can be determined in a known manner by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x₁/Tg₁+x₂/Tg₂= . . . +xₙ/Tgₙ, where xₙ is the mass fraction (% by weight/100) of the monomer n and Tgₙ is the glass transition temperature in kelvin of the homopolymer of the monomer n. Tg values for homopolymers are given in Polymer Handbook 2nd Edition, J. Wiley & Sons, New York (1975).

The base polymers are prepared by the emulsion polymerization process or by the suspension polymerization process, preferably by the emulsion polymerization process, with the polymerization temperature generally being from 40° C. to 130° C., preferably from 60° C. to 110° C. In the copolymerization of gaseous comonomers such as ethylene, 1,3-butadiene or vinyl chloride, the polymerization can also be carried out under super-atmospheric pressure, generally from 5 bar to 100 bar.

The polymerization is initiated using the water-soluble or monomer-soluble initiators or redox initiator combinations customary for emulsion polymerization or suspension polymerization. Examples of water-soluble initiators are the sodium, potassium and ammonium salts of peroxodisulfuric acid, hydrogen peroxide, t-butyl peroxide, t-butyl hydroperoxide, potassium peroxo-diphosphate, tert-butyl peroxopivalate, cumene hydro-peroxide, isopropylbenzene monohydroperoxide, azobis-isobutyronitrile. Examples of monomer-soluble initiators are dicetyl peroxydicarbonate, dicyclohexyl peroxydicarbonate, dibenzoyl peroxide. The initiators mentioned are generally used in an amount of from 0.01 to 0.5% by weight, based on the total weight of the monomers.

Redox initiators used are combinations of the initiators mentioned with reducing agents. Suitable reducing agents are the sulfites and bisulfites of alkali metals and of ammonium, for example sodium sulfite, derivatives of sulfoxyl acid such as zinc or alkali metal formaldehyde sulfoxylates, for example sodium hydroxy-methanesulfinate, and ascorbic acid, The amount of reducing agent is preferably from 0.01 to 0.5% by weight, based on the total weight of the monomers.

To control the molecular weight, regulating substances can be used during the polymerization. If regulators are used, these are usually used in amounts of from 0.01 to 5.0% by weight, based on the monomers to be polymerized, and are introduced separately or as premixed mixtures with reaction components. Examples of such substances are n-dodecyl mercaptan, tert-dodecyl mercaptan, mercaptopropionic acid, methyl mercapto-propionate, isopropanol and acetaldehyde. Preference is given to using no regulating substances.

To prepare aqueous polymer dispersions comprising modified polyvinyl alcohols, the modified polyvinyl alcohol having a latent carboxylic acid function and/or comprising phosphorus-containing comonomer units is used as protective colloid. Preference is given to polyvinyl alcohols comprising phosphorus-containing comonomer units from the group consisting of vinylphosphonic acid and methacrylic esters and acrylic esters of polyalkylene glycols which are end-modified by phosphoric acid and have C₂-C₄-alkylene units and from 1 to 100 oxyalkylene units. In addition, it is possible to use further protective colloids, for example partially hydrolyzed or fully hydrolyzed polyvinyl alcohols having a degree of hydrolysis of from 80 to 100 mol %, in particular partially hydrolyzed polyvinyl alcohols having a degree of hydrolysis of from 80 to 95 mol % and a Hoppler viscosity in 4% strength aqueous solution of from 1 to 30 mPas (method of Höppler at 20° C., DIN 53015). Preference is given to carrying out the polymerization without further protective colloids.

The modified polyvinyl alcohols are generally added in a total amount of from 1 to 20% by weight, preferably from 3 to 15% by weight, in each case based on the total weight of the monomers, in the polymerization. The protective colloid can either all be initially charged or part of it can be initially charged and part of it can be metered in. Preference is given to initially charging at least 5% by weight of the protective colloid, most preferably all of it.

The polymerization is preferably carried out without addition of emulsifiers. In exceptional cases, it can be advantageous for small amounts of emulsifiers, if appropriate from 1 to 5% by weight based on the amount of monomers, to be additionally added. Suitable emulsifiers include anionic, cationic and nonionic emulsifiers, for example anionic surfactants such as alkyl sulfates having a chain length of from 8 to 22 carbon atoms, alkyl or alkylaryl ether sulfates having from 8 to 22 carbon atoms in the hydrophobic radical and up to 100 ethylene oxide or propylene oxide units, alkylsulfonates or alkylarylsulfonates having from 8 to 22 carbon atoms, esters and monoesters of sulfosuccinic acid with monohydric alcohols or alkylphenols, or nonionic surfactants such as alkyl polyglycol ethers or alkylaryl polyglycol ethers having from 8 to 100 ethylene oxide and/or propylene oxide units.

It is possible for all of the monomers to be initially charged, all of them to be metered in or part of them to be initially charged and the remainder metered in after initiation of the polymerization. The preferred procedure is to initially charge from 50 to 100% by weight, based on the total weight of the monomers, and meter in the remainder. The metered additions can be carried out separately (spatially and temporally), or all or part of the components to be metered in can be introduced in preemulsified form.

Auxiliary monomers can, depending on their chemical nature, likewise be initially charged in their entirety or be metered in. Partial initial charging or metered addition is also possible. In the case of vinyl acetate polymerizations, the auxiliary monomers are metered in or initially charged as a function of their copolymerization parameters. Acrylic acid derivatives, for example, are metered in while vinylsulfonate can be initially charged.

The monomer conversion is controlled by means of the addition of initiator. The initiators are preferably all metered in.

After the polymerization is complete, an after-polymerization can be carried out by known methods in order to remove residual monomers, for example by means of an after-polymerization initiated using a redox catalyst. Volatile residue monomers can also be removed by means of distillation, preferably under reduced pressure, and, if appropriate, with inert entrainer gases such as air, nitrogen or steam being passed through or over the reaction mixture.

The aqueous dispersions obtainable in this way have a solids content of from 30 to 75% by weight, preferably from 50 to 65% by weight.

To produce the water-redispersible polymer powders, the corresponding aqueous dispersions are, if appropriate after addition of protective colloids as atomization aid, dried, for example by means of fluidized-bed drying, freeze drying or spray drying. The dispersions are preferably spray dried. Spray drying is carried out in customary spray-drying units, with atomization being able to be carried out by means of single-fluid, two-fluid or multifluid nozzles or by means of a rotary disk. The outlet temperature is generally selected so as to be in the range from 45° C. to 120° C., preferably from 60° C. to 90° C., depending on the unit, the Tg of the resin and the desired degree of drying.

A possible procedure is to spray dry polymer dispersions stabilized with protective colloids which are different from the modified polyvinyl alcohols, for example polymer dispersions containing partially hydrolyzed polyvinyl alcohol as protective colloid, in the presence of a modified polyvinyl alcohol having a latent carboxylic acid function and/or comprising phosphorus-containing comonomer units as atomization aid.

A further possibility is to spray dry aqueous polymer dispersions which contain modified polyvinyl alcohol having a latent carboxylic acid function, preferably polyvinyl alcohol comprising phosphorus-containing comonomer units, as protective colloid in the presence of an atomization aid, with the atomization aid being able to be a modified polyvinyl alcohol having a latent carboxylic acid function or a modified polyvinyl alcohol comprising phosphorus-containing comonomer units. Alternatively, it is possible to use protective colloids which are different from the modified polyvinyl alcohols as atomization aid.

In general, the atomization aid is used in a total amount of from 3 to 30% by weight, based on the polymeric constituents of the dispersion. This means that the total amount of protective colloid prior to the drying process should be at least from 3 to 30% by weight, based on the polymer component; preference is given to using from 5 to 20% by weight based on the polymer component.

Suitable atomization aids which are different from the modified polyvinyl alcohols are partially hydrolyzed and fully hydrolyzed polyvinyl alcohols having a degree of hydrolysis of from 75 to 100 mol %; polyvinyl-pyrrolidones; polysaccharides in water-soluble form, e.g. starches (amylose and amylopectin), celluloses and their carboxymethyl, methyl, hydroxyethyl, hydroxy-propyl derivatives; proteins such as casein or caseinate, soybean protein, gelatin; lignosulfonates; synthetic polymers such as poly(meth)acrylic acid, copolymers of (meth)acrylates with carboxyl-functional comonomer units, poly(meth)acrylamide, polyvinyl-sulfonic acids and their water-soluble copolymers; melamin-formaldehyde sulfonates, naphthalene-formaldehyde sulfonates, styrene-maleic acid and vinyl ether-maleic acid copolymers. Preference is given to using partially hydrolyzed polyvinyl alcohols having a degree of hydrolysis of from 80 to 95 mol % and a Höppler viscosity in 4% strength aqueous solution of from 1 to 30 mPas (method of Höppler at 20° C., DIN 53015) as atomization aid.

Greatest preference is given to water-redispersible polymer powders which are obtained by spray drying of aqueous polymer dispersions which are stabilized with partially hydrolyzed polyvinyl alcohol or a polyvinyl alcohol modified with phosphorus-containing comonomer units and are dried in the presence of a polyvinyl alcohol modified with phosphorus-containing comonomer units or a modified polyvinyl alcohol having a latent carboxylic acid function as atomization aid.

A content of up to 1.5% by weight of antifoam, based on the base polymer, has frequently been found to be useful in atomization. To increase the storage stability by improving the blocking stability, particularly in the case of powders having a low glass transition temperature, the powder obtained can be treated with an antiblocking agent (anticaking agent), preferably in an amount of up to 30% by weight, based on the total weight of polymeric constituents. Examples of antiblocking agents are calcium or magnesium carbonate, talc, gypsum, silica, kaolins, silicates having particle sizes which are preferably in the range from 10 nm to 10 μm.

The viscosity of the feed to be atomized is set via the solids content so that a value of <500 mPas (Brookfield viscosity at 20 revolutions and 23° C.), preferably<250 mPas, is obtained. The solids content of the dispersion to be atomized is >35%, preferably >40%.

To improve the use properties, further additives can be added during atomization. Further constituents present in dispersion powder compositions in preferred embodiments are, for example, pigments, fillers, foam stabilizers, hydrophobicizing agents.

The aqueous polymer dispersions and the water-redispersible polymer powders can be used in the applications typical for them, for example in building-chemical products in combination with hydraulically setting or hydraulically curing binders such as cements (portland, alumina, pozzolanic, slag, magnesia, phosphate cement), gypsum plaster, water glass, for the production of building adhesives, in particular cement-containing tile adhesives, thermal insulation systems, plasters and renders, in particular lime-cement renders, troweling compositions, in particular self-leveling troweling compositions, flooring screeds, sealing slurries, jointing mortar and paints, also as sole binder for coating compositions and adhesives or as coating agent or binder for textiles and paper.

The following examples serve to illustrate the invention:

### EXAMPLE 1

Preparation of a Copolymer of vinyl Acetate and methyl acrylate

A 17 l autoclave was charged with 328.7 g of methyl acrylate, 4090 g of vinyl acetate and 4340 g of methanol. This initial charge was heated to 58° C. and stirred. The initiator solution to be added consisted of 86.2 g of Trigonox 23 (t-butyl perneodecanoate) dissolved in 310.1 g of methanol. At 58° C., a pulse of 38.5 g of the initiator feed stream was added. Introduction of the initiator feed stream at a feed rate of 78.9 g/h was then commenced. The reaction was maintained at a constant temperature of 58° C.

The monomer feed consisted of 4960 g of vinyl acetate and 396.9 g of methyl acrylate. 45 minutes after the commencement of introduction of the initiator, the introduction of the monomer feed was commenced at a rate of 2680 g/h.

The introduction of initiator was continued for 1 hour longer than the introduction of the monomer. 15.1 g of Trigonox 23 were then added and the reaction temperature was increased from 60° C. to 70° C. for a period of 90 minutes. The solid resin which had been prepared in this way was then dispensed in the hot state and diluted with 19.7 kg of methanol (rinsing of the vessel).

This gave a solid resin of 67.5% (undiluted sample), after addition of methanol 25.9% (Fikentscher K value, 1% in methanol: 32).

### EXAMPLE 2

Hydrolysis of a Copolymer of Vinyl Acetate and Methyl Acrylate

In a 120 l autoclave, the solid resin from example 1 was adjusted to a solids content of 25.0% by means of methanol. 36.95 kg of this solid resin were mixed with 7.68 kg of methyl acetate and heated to a temperature of 40° C. The static contents of the vessel were then covered with a layer of 2.24 kg of methanol. A solution of 581.5 g of aqueous sodium hydroxide (46% strength) in 1116 g of methanol was then added. The power uptake of the stirrer was monitored over time.

The reaction time to occurrence of the viscosity maximum (=gel point) was 10 minutes. After a further 10 minutes after the gel point had been reached, the reaction was stopped with 791.6 g of acetic acid. The solvents methanol and methyl acetate were then driven off by introduction of hot steam and a 15.9% strength solution of a copolymer of vinyl acetate-vinyl alcohol-methyl acrylate was obtained. The viscosity of a 4% strength aqueous solution measured by the Hoppler method was 3.93, and the hydrolysis number was 144.

### EXAMPLE 3

Preparation of a copolymer of vinyl acetate and a meth-acrylic ester of a polyethylene glycol which has been end-modified with phosphoric acid (Sipomer® PAM 100, commercial product from Rhodia)

A 17 l autoclave was charged with 5620 g of vinyl acetate and 1410 g of methanol together with 21.36 g of t-butyl peroxy-2-ethylhexanoate (TBPEH). This initial charge was heated to 60° C. The reaction was maintained at a constant temperature of 58° C. Immediately after commencement of the polymerization, introduction of the monomer feed consisting of 281 g of Sipomer® PAM 100 and 590.1 g of methanol was commenced at a rate of 217.5 g/h; addition time: 4 h. The stirrer was then switched off and the reaction temperature was maintained at 60° C. for a further 4 hours. The solid resin which had been prepared in this way was then cooled to 30° C. and during cooling diluted with about 8140 g of methanol (rinsing of the vessel).

After a further rinse, a solid resin having a solids contents of 31.0% in methanol (Fikentscher K value, 1% in methanol: 44) was obtained.

### EXAMPLE 4

Hydrolysis of the Copolymer from Example 3

In a 120 l autoclave, the solid resin from example 3 was adjusted to a solids content of 25.0% by means of methanol. 18.43 kg of this solid resin were mixed with 3.56 kg of methyl acetate and heated to a temperature of 40° C. The static contents of the vessel were then covered with a layer of 2.18 kg of methanol. A solution of 94.4 g of aqueous sodium hydroxide (46% strength) in 416.4 g of methanol was then added. The power uptake of the stirrer was monitored over time.

The reaction time to occurrence of the viscosity maximum (=gel point) was 6 minutes. After a further 12 minutes after the gel point had been reached, the reaction was stopped by means of 367 g of acetic acid dissolved in 4 kg of methanol. The solvents methanol and methyl acetate were then driven off by introduction of hot steam and a 23.4% strength solution of a copolymer of vinyl acetate-vinyl alcohol-methyl acrylate was obtained. The viscosity of a 4% strength aqueous solution determined by the Höppler method was 6.43, and the hydrolysis number was 78.

### EXAMPLE 5

Preparation of a Polyvinyl Alcohol with 9.1% by Weight of Methyl Acrylate Comonomer

The procedure of examples 3 and 4 was repeated using the following amounts: the initial charge comprised 1.11 kg of methanol, 21.1 g of TBPEH and 5550 g of vinyl acetate. After commencement of the reaction, 554.6 g of methyl acrylate dissolved in 860 g of methanol were metered in over a period of 5 hours. 5.55 g of TBPEH dissolved in 5.55 g of methanol were then added and the mixture was stirred at 60° C. for another 1 hour. After switching off the stirrer, the temperature was maintained at 60° C. for a further 6 hours. The mixture was then cooled and diluted with 8030 g of methanol, and the contents of the vessel were then rinsed out a number of times with methanol. This gave a 32.2% strength solid resin solution, Fikentscher K value: 33.2 (1% in MeOH).

13.34 kg of this modified solid resin were covered with a layer of 2251 g of methanol; for hydrolysis, 299.3 g of NaOH (46% strength) were dissolved in 3.13 kg of methanol and added. The gel point was reached after 4 minutes, and the hydrolysis was stopped after 10 minutes by means of 408 g of acetic acid dissolved in 4 kg of methanol. Driving off the solvents gave a 19.2% strength solution of a modified polyvinyl alcohol having a hydrolysis number of 198, a K value of 23 and a viscosity determined by the Höppler method of 4.23.

### EXAMPLE 6

Polymerization of Vinyl Acetate and Ethylene Using a Modified Polyvinyl Alcohol from Example 4

A 5 l laboratory autoclave was charged with 944 g of polyvinyl alcohol from example 4 in 16.6% strength aqueous solution and 1030 g of demineralized water and 1930 g of vinyl acetate. The pH of the initial charge was adjusted to pH=4. The autoclave was then pressurized to 20 bar with 250 g of ethylene.

The initiator solutions to be introduced comprised 48.2 g of t-butyl hydroperoxide (1.5% strength) and 48.2 g of ascorbic acid (2.5% strength). Introduction of both solutions was commenced at a rate of 12.7 g/h after a temperature equilibrium of 55° C. had been reached. After commencement of the reaction, the metering rates were maintained and the reaction temperature was increased to 85° C.

1 hour after commencement of the reaction, 482 g of vinyl acetate and 218 g of modified polyvinyl alcohol from example 4 (16.6% strength in water) were metered in over a period of 2 hours.

The metered additions of the initiator solutions were continued over the total 3.5 hours of the reaction.

After depressurization and after polymerization using t-BHP/ascorbic acid, a dispersion having a solids content of 54.5%, a Brookfield viscosity of 160 mPas (20 rpm) and a density of 1.08 g cm⁻³ was obtained.

### EXAMPLE 7

The procedure of example 6 was repeated, but the modified polyvinyl alcohol from example 2 was used for the polymerization. This gave a dispersion having a solids content of 54.7%, a Brookfield viscosity of 185 mPas (20 rpm) and a density of 1.08 g cm⁻³.

The dispersions obtained in examples 6 and 7 were cement-stable: the viscosity of a mixture of 100 parts by weight of portland cement and 10 parts by weight of polymer (example 6) had increased to 138% 1 hour after mixing. When the polymer from example 7 was used, the viscosity increased to 132%. Both figures are based on the viscosity increase of pure portland cement mixed only with water as comparative value.

The modified polyvinyl alcohols from examples 2, 4 and 5 were used as atomization aid for spray drying a vinyl acetate-ethylene copolymer dispersion I (solids content: 58%, Tg: 16° C.) stabilized with polyvinyl alcohol (1% by weight of a polyvinyl alcohol having a degree of hydrolysis of 88 mol % and a Hdppler viscosity of 13 mPas) and a vinyl acetate-ethylene copolymer dispersion II (solids content: 54%, Tg: 10° C.) stabilized with polyvinyl alcohol (5% by weight of a polyvinyl alcohol having a degree of hydrolysis of 88 mol % and a Höppler viscosity of 13 mPas).

Spray drying was carried out using a dryer from Niro having a single-fluid nozzle (30 bar, 65° C., throughput: 40 kg/h). The inlet temperature on the dryer was 140° C., and the outlet temperature was 80° C. The redispersion powders were produced with 11% by weight (dispersion II) or 16% by weight (dispersion I) of antiblocking agent.

For comparison, the dispersions I and II were spray dried in the presence of a partially hydrolyzed poly-vinyl alcohol having a degree of hydrolysis of 88 mol % and a Hoppler viscosity of 4 mPas.

The following samples resulted:

Sample 1 (Comparison):

Dispersion powder obtained by spray drying of dispersion I in the presence of 5% by weight of a partially hydrolyzed polyvinyl alcohol having a degree of hydrolysis of 88 mol % and a Hoppler viscosity of 4 mPas and containing 16% by weight of antiblocking agent.

Sample 2:

Dispersion powder obtained by spray drying of dispersion I in the presence of 5% by weight of the modified polyvinyl alcohol from example 2 and containing 16% by weight of antiblocking agent.

Sample 3:

Dispersion powder obtained by spray drying of dispersion I in the presence of 5% by weight of the modified polyvinyl alcohol from example 5 and containing 16% by weight of antiblocking agent.

Sample 4 (Comparison):

Dispersion powder obtained by spray drying of dispersion II in the presence of 2% by weight of a partially hydrolyzed polyvinyl alcohol having a degree of hydrolysis of 88 mol % and a Hoppler viscosity of 4 mPas and containing 11% by weight of antiblocking agent.

Sample 5:

Dispersion powder obtained by spray drying of dispersion II in the presence of 2% by weight of the modified polyvinyl alcohol from example 2 and containing 11% by weight of antiblocking agent.

Sample 6:

Dispersion powder obtained by spray drying of dispersion II in the presence of 2% by weight of the modified polyvinyl alcohol from example 5 and containing 11% by weight of antiblocking agent.

The redispersion powders were tested for the adhesive pull strengths in tile adhesives in the following formulation (1% by weight or 3% by weight of dispersion powder);

| | | |
|---|---|---|
| silica sand | 636 | parts (616 parts) |
| portland cement | 350 | parts |
| cellulose | 4 | parts |
| dispersion powder | 10 | parts (30 parts) |

The adhesive pull strengths were determined in accordance with DIN CEN 1897 under 4 storage conditions (S1 to S4):

28 d standard atm. (S1):
28 days dry storage in a standard atmosphere (23° C./50% atmospheric humidity; DIN 50014)

7 d standard atm./21 d wet (S2):
7 days dry storage (standard atmosphere)/21 days wet storage

14 d standard atm./14 d 70° C./1 d 14 days dry storage/14 days

1 d standard atm. (S3):
hot storage at 70° C., 1 day dry storage freeze-thaw (S4):

25 freeze-thaw cycles

The following results were obtained:

TABLE 1
Comparison of the adhesive pull strengths
at 1% by weight of powder:

| Sample | S1 (N/mm²) | S2 (N/mm²) | S3 (N/mm²) | S4 (N/mm²) |
|---|---|---|---|---|
| 1 | 0.65 | 0.71 | 0.40 | 0.15 |
| 2 | 0.78 | 0.61 | 0.43 | 0.21 |
| 3 | 0.90 | 0.88 | 0.45 | 0.18 |
| 4 | 0.68 | 0.70 | 0.40 | 0.14 |
| 5 | 0.76 | 0.73 | 0.44 | 0.19 |
| 6 | 0.73 | 0.75 | 0.43 | 0.21 |

TABLE 2
Comparison of the adhesive pull strengths
at 3% by weight of powder:

| Sample | S1 (N/mm²) | S2 (N/mm²) | S3 (N/mm²) | S4 (N/mm²) |
|---|---|---|---|---|
| 1 | 1.20 | 0.73 | 0.80 | 0.43 |
| 2 | 1.33 | 0.80 | 0.99 | 0.52 |
| 3 | 1.27 | 0.84 | 1.05 | 0.54 |
| 4 | 1.10 | 0.77 | 0.82 | 0.53 |
| 5 | 1.08 | 0.81 | 0.99 | 0.58 |
| 6 | 1.02 | 0.86 | 0.92 | 0.61 |

TABLE 3
Comparison of the open time via adhesive
pull strengths at 1% by weight of powder:

Sample

| | 1 | 2 | 3 | 4 | 5 | 6 |
|---|---|---|---|---|---|---|
| 5 min * | 0.65 | 0.78 | 0.90 | 0.85 | 0.76 | 0.73 |
| 20 min * | 0.27 | 0.29 | 0.32 | 0.40 | 0.42 | 0.25 |
| 30 min * | 0.16 | 0.19 | 0.20 | 0.15 | 0.20 | 0.10 |

* Adhesive pull strengths in N/mm² after an open time of 5, 20 and 30 minutes.

TABLE 4
Comparison of the open time via adhesive
pull strengths at 3% by weight of powder:

Sample

| | 1 | 2 | 3 | 4 | 5 | 6 |
|---|---|---|---|---|---|---|
| 5 min * | 1.20 | 1.33 | 1.27 | 1.10 | 1.08 | 1.02 |
| 20 min * | 0.40 | 0.72 | 0.76 | 0.49 | 0.57 | 0.38 |
| 30 min * | 0.16 | 0.44 | 0.47 | 0.24 | 0.38 | 0.21 |

* Adhesive pull strengths in N/mm² after an open time of 5, 20 and 30 minutes.

Discussion of the Results:

As can be seen from tables 1 and 2, redispersion powders which comprise modified polyvinyl alcohols as protective colloids display significantly improved adhesive pull strengths after hot storage and also after wet storage and freeze-thaw cycling. This applies both in the case of modification of the polyvinyl alcohols with methyl acrylate, a latent carboxylic acid function which is slowly set free by hydrolysis in cement-containing (strongly alkaline) systems, and in the case of polyvinyl alcohols which bear phosphoric acid groups.

Furthermore, it can be seen (tables 3 and 4) that the open time, measured via adhesive pull strengths, is significantly improved in the case of redispersion powders comprising polyvinyl alcohols containing methyl acrylate.

1-13. (canceled)

14. A water redispersible polymer powder, comprising:
a) base polymer particles prepared by polymerizing monomers comprising at least one monomer selected from the group consisting of vinyl esters of optionally branched C₁₋₁₅ alkylcarboxylic acids, (meth)acrylic esters of C₁₋₁₅ alcohols, vinyl aromatics, monoolefins, dienes, and vinyl halides; and
b) at least one modified polyvinyl alcohol protective colloid selected from the group consisting of polyvinyl alcohol copolymers containing copolymer units having a latent carboxylic acid functionality, copolymer units containing phosphorous, and copolymers containing both copolymer units having a carboxylic acid functionality and copolymer units containing phosphorus.

15. The polymer composition of claim 14, wherein the modified polyvinyl alcohols comprise one or more comonomer units selected from the group consisting of methacrylic esters and acrylic esters of C₁₋₁₅ alcohols.

16. The polymer composition of claim 14, wherein the modified polyvinyl alcohols comprise one or more comonomer units selected from the group consisting of vinylphosphonic acid, and methacrylic esters and acrylic esters of polyalkylene glycols which are end-modified by phosphoric acid and contain from 1 to 100 C₂₋₄ oxyalkylene units.

17. The polymer composition of claim 14, obtained by means of spray drying an aqueous polymer dispersion stabilized with at least one modified polyvinyl alcohol having a latent carboxylic acid function or a modified polyvinyl alcohol comprising phosphorus-containing comonomer units, in the presence of partially hydrolyzed, unmodified polyvinyl alcohol as an atomization aid.

18. A process for preparing a water redispersible polymer powder of claim 14, comprising polymerizing a monomer mixture comprising at least one monomer selected from the group consisting of vinyl esters of optionally branched C₁₋₁₅ alkylcarboxylic acids, (meth)acrylic esters of C₁₋₁₅ alcohols, monolefins, dienes, vinyl aromatics, and vinyl halides, in the presence of at least one protective colloid selected from the group consisting of modified polyvinyl alcohol copolymers containing copolymer units having a latent carboxylic acid functionality, copolymer units containing phosphorous, and copolymers containing both copolymer units having a carboxylic acid functionality and copolymer units containing phosphorus, and spray drying to form a polymer powder.

19. The process of claim 18, wherein a further polyvinyl alcohol protective colloid different from said modified polyvinyl alcohol copolymer is present during polymerization.

20. The process of claim 18, wherein prior to spray drying, a further protective colloid is added.

21. The process of claim 20, wherein said further protective colloid comprises a polyvinyl alcohol homopolymer or copolymer not containing latent carboxylic acid units and not containing units containing phosphorous.

22. The process of claim 20, wherein said further protective colloid comprises at least one protective colloid selected from the group consisting of polyvinyl alcohol copolymers containing copolymer units having a latent carboxylic acid functionality, copolymer units containing phosphorous, and copolymers containing both copolymer units having a carboxylic acid functionality and copolymer units containing phosphorus.

23. A process for the preparation of a water redispersible polymer powder of claim 14, comprising supplying a polymer dispersion stabilized with one or more protective colloids and spray drying to form a polymer powder, and prior to spray drying, adding a further protective colloid selected from the group consisting of modified polyvinyl alcohol copolymers containing copolymer units having a latent carboxylic acid functionality, copolymer units containing phosphorous, and copolymers containing both copolymer units having a carboxylic acid functionality and copolymer units containing phosphorus.

24. A building construction composition comprising a mineral filler and a redispersible polymer powder of claim 14.

25. A building construction composition comprising a hydraulically settable binder and a redispersible polymer powder of claim 14.

26. The building construction composition of claim 25 which is alkaline such that latent carboxylic acid units in the redispersible polymer powder are at least partially hydrolyzed, liberating alcohol.

27. The building construction composition of claim 25, wherein said hydraulically settable binder is selected from the group consisting of gypsum, lime, cement, waterglass, and mixtures thereof.

28. A binder-containing paper a textile product containing at least one redispersible polymer powder of claim 14.
